(19) United States
(12) Patent Application Publication
(10) Pub. No.: US 2010/0270695 A1
(43) Pub. Date: Oct. 28, 2010

(54) Processing Nanoparticles by Micellization of Blocky-Copolymers in Subcritical and Supercritical Solvents

(76) Inventors: Maciej Radosz, Laramie, WY (US); Youqing Shen, Laramie, WY (US)

Correspondence Address: DAVIS, BROWN, KOEHN, SHORS & ROBERTS, P.C.;THE DAVIS BROWN TOWER, 215 10TH STREET SUITE 1300, DES MOINES, IA, 50309, US

(21) Appl. No.: 12/440,105

(22) PCT Filed: Sep. 5, 2007
(86) PCT No.: PCT/US07/19370

§ 371 Date: Jul. 6, 2010

Related U.S. Application Data
(60) Provisional application No. 60/842,414, filed on Sep. 5, 2006.

(51) Int. Cl. B01J 13/02

(52) U.S. Cl. 264/4.1

(57) ABSTRACT

Disclosed is a process for forming nanoparticles by the micellization of blocky copolymers in either subcritical or supercritical solvents and antisolvents. The nanoparticles are suited for use as delivery vehicles for drugs and genes.

### BACKGROUND OF THE INVENTION

The invention relates generally to nanoparticles and, more specifically, to a process for forming nanoparticles by the micellization of blocky copolymers in either subcritical or supercritical solvents.

The nanoparticles used for drug- and gene-delivery are made of micelles formed by blocky copolymers in an aqueous solution. Blocky copolymers are defined are diblock, multiblock or graft copolymers. FIG. 1 provides an example that illustrates micellization of a poly(ethylene glycol)-block-poly(ε-caprolactone) copolymer, PEG-b-PCL, including the drug (shown as dots) that is initially dissolved in water and eventually captured by the micelle core. The example shown in FIG. 1 is for a brush-shaped copolymer synthesized and characterized in our previous work [Xu, P.; Tang. H.; Li, S.; Ren, J.; Van Kirk, E.; Murdoch, W. J.; Radosz, M.; Shen, Y. Enhanced Stability of Core-Surface Cross-Linked Micelles Fabricated from Amphiphilic Brush Copolymers. Biomacromolecules. 5, 1736, (2004 )], but this copolymer does not have to be brush-shaped; the micellar nanoparticles can be formed by other types of block and graft copolymers as well.

The formation and processing of PEG-b-PCL nanoparticles in aqueous solutions is described by Jette et al. [Jette, K. K.; Law, D.; Schmitt, E. A.; Kwon, G. S. Preparation and Drug Loading of Poly(Ethylene Glycol)-block-Poly(ε-Caprolactone) Micelles Through the Evaporation of a Cosolvent Azeotrope. Pharmaceutical Research, 21, 1184, (2004 )] Johnson and Prud'homme [Johnson, B. K.; Prudhomme, R. K. Flash NanoPrecipitation of Organic Actives and Block Copolymers using a Confined Impinging Jets Mixer. Aust. J. Chem. 56, 1021 (2003 ); Johnson, B. K.; Prudhomme, R. K. Chemical Processing and Micromixing in Confined Impinging Jets. AIChE Journal. 49, 2264, (2003); Johnson, B. K.; Prudhomme, R. K. Mechanism for Rapid Self-Assembly of Block Copolymer Nanoparticles. Phys. Rev. Let. 91(11), 118302(4), (2003)] and others. Examples of technical challenges associated with making such nanoparticles in aqueous solutions are, for example, how to optimize the drug concentration in the micelle core and how to recover dry micelles. In a conventional ‘freeze-dry’ approach to micelle recovery, the whole solution is frozen to preserve the micelle structure and to remove water by sublimation under vacuum.

An alternative to an incompressible liquid solvent, such as water, is a subcritical or supercritical solvent, that is, a compressed but compressible fluid either below or above its critical temperature. Such near-critical fluid solvents are easier to recover, less viscous, pressure sensitive, and hence allow for unique processing, purification, and fractionation approaches. [Kendall, J. L.; Canelas, D. A.; Young, J. L.; DeSimone, J. M. Polymerizations in Supercritical Carbon Dioxide. Chem. Rev., 99, 543, (1999 ).] An example of block-copolymer micellization in supercritical fluids is the work of DeSimone's group [Buhler, E.; Dobrynin, A. V.; DeSimone, J. M.; Rubinstein, M. Light-Scattering Study of Diblock Copolymers in Supercritical Carbon Dioxide: CO2 Density-Induced Micellization Transition. Macromolecules, 31, 7347, (1998 ); Triolo, A.; Triolo, F.; Lo Celso, F.; Betts, D. E.; McClain, J. B.; DeSimmone, J. M.; Wignall, G. D.; Triolo, R. Critical micellization density: A small-angle-scattering structural study of the monomer-aggregate transition of block copolymers in supercritical CO2. Phys. Rev. E, 62, 5839, (2000 ); Triolo, R.; Triolo, A.; Triolo, F.; Steytler, D. C.; Lewis, C. A.; Heenan, R. K.; Wignall, G. D.; DeSimmone, J. M. Structure of diblock copolymers in supercritical carbon dioxide and critical micellization pressure. Phys. Rev. E, 61, 4640, (2000 )] who reported critical micelle densities, that is densities below which micellization occurs, for diblock copolymers in carbon dioxide, some of which were also later calculated by Colina et al. [Colina, C. M.; Hall, C. K.; Gubbins, K. E. Phase behavior of PVAC-PTAN block copolymer in supercritical carbon dioxide using SAFT. Fluid Phase Equilib., 194 -197, 553, (2002 )]. However, there are no open or patent literature references to forming and processing drug- and gene-delivery nanoparticles in near-critical fluid solvents.

### SUMMARY OF THE INVENTION

The invention consists of a process in which, instead of processing drug-delivery nanoparticles in water, they are processed in a compressed subcritical or supercritical fluid, that is, a fluid that is either below or above its critical temperature. Such a near-critical fluid is much less viscous and hence allows for better control of the drug transport and partitioning, and more effective micelle separation, for example, via crystallization from and decompression of the high-pressure micellar solution, without having to freeze the solvent. While drug- and gene-delivery nanoparticles are a lead example, this disclosure concerns all nanoparticles formed by copolymers in near-critical fluids.

### BRIEF DESCRIPTION OF THE DRAWINGS

FIG. 1 is a schematic diagram of a preferred embodiment of the present invention showing the micellization of a poly(ethylene glycol)-block-poly(ε-caprolactone) copolymer, PEG-b-PCL, including the drug (shown as dots).

FIG. 2 is a simplified schematic diagram of the experimental apparatus.

FIG. 3 is a schematic diagram of the data-acquisition and control systems.

FIG. 4 is a graph of the scattered light intensity as a function of temperature; argon ion laser at 488 nm.

FIG. 5 is a graph of the scattered light intensity as a function of pressure; argon ion laser at 488 nm.

FIG. 6 is a pressure-temperature phase diagram showing the cloud-point (fluid-liquid) transitions, critical micelle temperatures and critical micelle pressures.

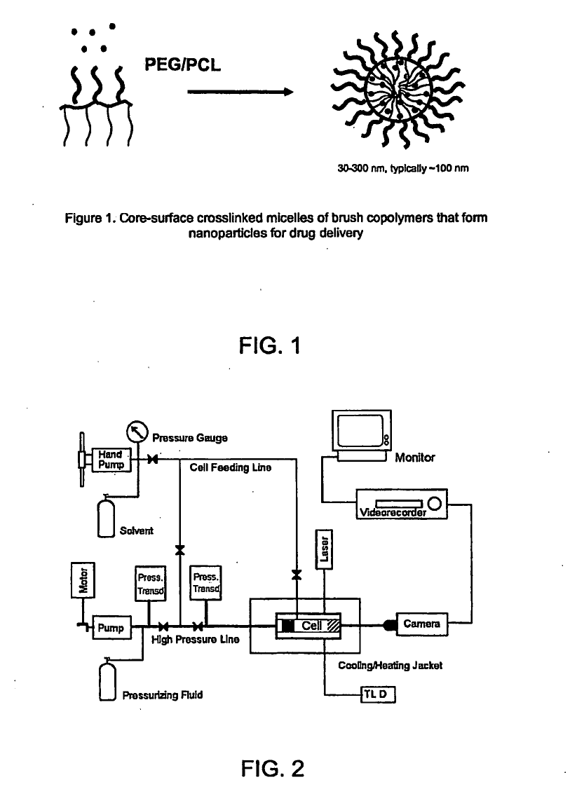

### DESCRIPTION OF THE INVENTION

This invention is illustrated by, but not limited to, the following examples of block and graft copolymers that can be considered as precursors for drug-delivery nanoparticles: poly(ethylene glycol)-block-polyesters such as PEG-b-poly(ε-caprolactone), shown below, PEG-b-poly(lactide), PEG-b-poly(carbonates), PEG-poly(alkylcyanoacrylates), and other copolymers.

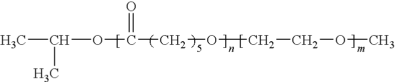

### Examples of Solvents

This invention is illustrated by, but not limited to, the following examples of near-critical solvents that can be considered for processing of drug-delivery nanoparticles: dimethyl ether, chlorodifluoromethane (Freon22 ), other freons, other near-critical solvents of variable polarity, cosolvents, and antisolvents, including supercritical antisolvents (SAS).

### Cloud-Point and Order-Disorder Experiments

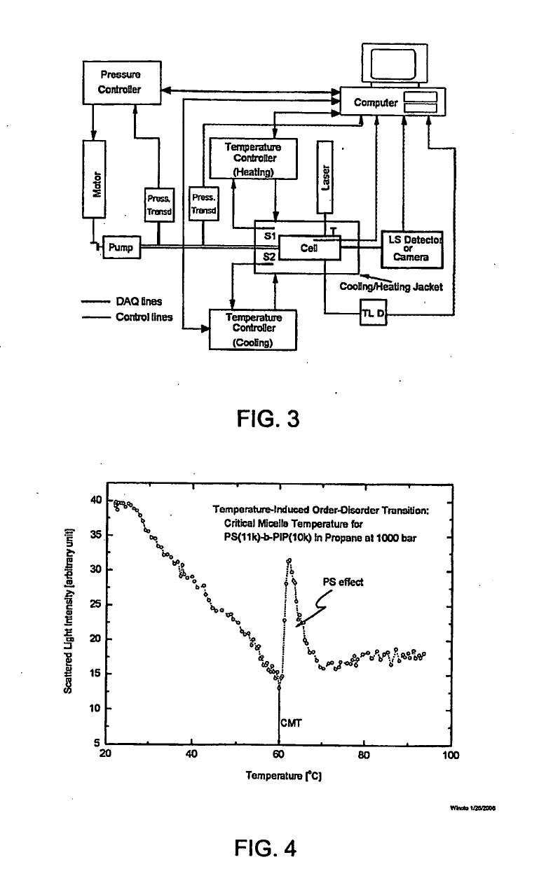

The cloud-point and critical micelle temperatures and pressures (CMT and CMP) are measured in a small (about 1 cc in volume) high-pressure variable-volume cell coupled with transmitted- and scattered-light intensity probes and with a borescope for visual observation of the phase transitions. The cloud points reported in this work are detected with a transmitted-light intensity probe and CMT and CMP are detected with a scattered-light intensity probe. A simplified schematic of the apparatus is shown in FIG. 2. This apparatus is equipped with a data-acquisition and control systems shown in FIG. 3. The control system allows not only for constant temperature and pressure measurements, but also for decreasing and increasing temperature and pressure at a constant rate.

A selected amount of sample is loaded into the cell, which is then brought to and maintained at a desired temperature. The cell has a floating piston, which is moved to decrease the volume of the cell, to compress the mixture without having to change the mixture composition. After the mixture is well equilibrated in a one-phase region by stirring at constant temperature and pressure, there are two choices: an isothermal experiment and isobaric experiment. In the isothermal experiment, the pressure is decreased slowly, while in the isobaric experiment the temperature is decreased slowly, until the solution turns turbid, which indicates the onset of phase separation. Upon crossing the phase boundary from the one-phase side, transmitted-light intensity (TLI) starts decreasing. Conversely, upon approaching the phase boundary from the two-phase side, TLI starts increasing. In all cases, the TLI data are stored as a function of time, temperature and pressure.

The micellar ODT transitions are probed using high-pressure dynamic light scattering. The intensity of scattered light and the hydrodynamic radius sharply increase upon the microphase separation, which is the basis of ODT detection. In this work, we focus on a low concentration range where it is safe to assume a microphase separation that corresponds to spherical-micelle formation.

For these measurements, the high-pressure equilibrium cell described in the previous section is coupled with an Argon Ion Laser (National Laser) operating at λ of 488 nm and a Brookhaven BI-9000 AT correlator. The detector has a band-pass filter to minimize the effects of fluorescence from the sample or stray light from sources other than the incident beam. The coherence area is controlled with a pinhole placed before the detector. The laser and detector are interfaced with the high-pressure cell via optical fibers produced by Thorlabs.

The hydrodynamic radius R_{H}, the radius of an equivalent sphere that gives the same frictional resistance to linear translation as the copolymer aggregate, is estimated from the Stokes-Einstein equation [Mazer, N. A., Laser Light Scattering in Micellar Systems. In Dynamic Light Scattering, Pecora, R, Ed. Plenum Press: New York, 1985]:

$${R}_{H} = \frac{kT}{6 {πη}_{0} D} \qquad ( 1 )$$

where k is the Boltzmann constant, η₀ is the solvent viscosity, T is the absolute temperature, and D is the diffusion coefficient determined from dynamic light scattering by extrapolating the first reduced cumulant to the zero wave vector.

The disclosed approach is demonstrated to be feasible for a model diblock system, namely polystyrene-b-polyisoprene (PS-b-PI) in near critical propane. While this system is nonpolar, and not practical for drug delivery, it captures the main features of a diblock placed in a selective compressible solvent. In this case, polystyrene, in contrast to polyisoprene, does not ‘like’ propane, and hence it forms the core; polyisoprene forms the corona. In the examples presented below, the styrene block is reminiscent of a core forming block (for example, PCL), while the polystyrene homopolymer trace is reminiscent of a drug molecule that has affinity to the micelle core. The PS-b-PI material used for this example does not exhibit crystallizability; the other block copolymers used to make nanoparticles may and likely will exhibit crystallizability, which will allow for separating the nanoparticles by crystallization.

### Critical Micelle Temperature (CMT)

Having dissolved PS-b-PI in propane at pressures above the cloud-point pressure, the critical micelle temperature (CMT) is found to be 60° C., for example, at a constant pressure of 1000 bar, as shown in FIG. 4. This peak reflects a minor unreacted PS impurity that precipitates from the solution before being absorbed by the micelle core.

### Critical Micelle Pressure (CMP)

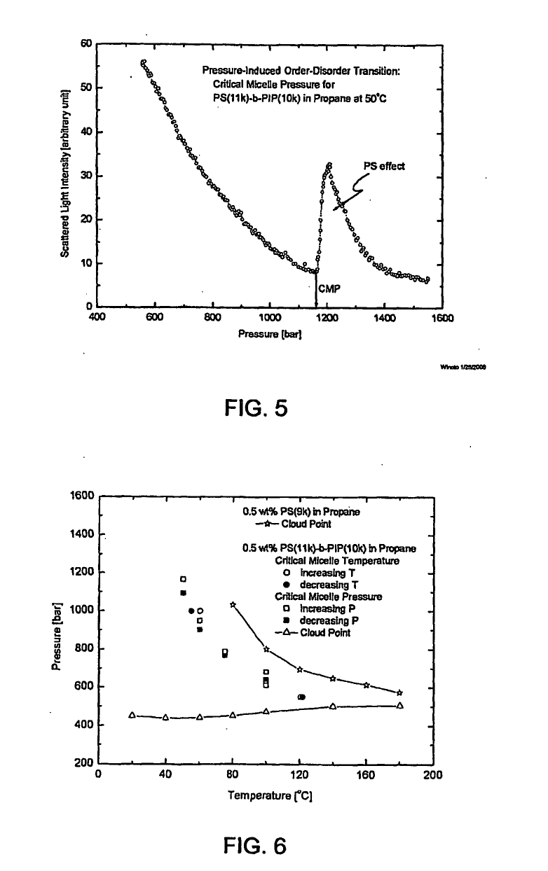

Increasing pressure of the micellar solution leads to disorder, and hence to a critical micelle pressure (CMP), which turns out to be completely and rapidly reversible. A sample CMP result for the same system is shown in FIG. 5. CMP is followed by an analogous peak attributable to a small fraction of unreacted PS that momentarily precipitates upon decreasing pressure before being absorbed by the micelle core.

### CMT/CMP Boundary

Still for the same system of PS-b-PI in propane, all the phase boundary points measured in this work are plotted in pressure-temperature coordinates in FIG. 6. The stars indicate a cloud-point curve for polystyrene alone, which separates the one-phase region (homogeneous solution) at high pressures from a two-phase region at lower pressures. The triangles indicate a corresponding cloud-point curve for PS-b-PI (one phase above, two phases below). The circles indicate CMT's and the squares indicate CMP's, all of which are reversible and approximately self consistent. They point to a single ODT curve (disordered state above, micellar state below). Incidentally, such PT phase diagrams further support the hypothesis that the PS “anomalous micellization” peaks are due to the precipitation of a trace homopolymer that is of the same kind as the core-forming block. FIG. 6 strongly suggests that trace PS must precipitate below the PS cloud-point pressure curve, at the onset of CMP, which causes the peak labeled “PS effect.” This is because the cloud-point curve for the PS impurity must lie below the PS cloud-point curve shown in FIG. 6 as the impurity concentration is much lower than that used in our cloud-point experiments.

Despite the minute concentration of free PS, the prominent scattering intensity peak reflects the onset of the trace PS precipitation, which is quickly overtaken by the PS absorption in the micelle core. This peak can be eliminated, by repeated purification, as demonstrated by Lodge et al. [Lodge, T. P; Bang, J.; Hanley, K. J.; Krocak, J.; Dahlquist, S.; Sujan, B.; Ott, J. Origins of Anomalous Micellization in Diblock Copolymer Solutions. Langmuir, 19, 2103, (2003 )], but it does not alter PMT, and in fact it can help to pinpoint it (as shown with an arrow in FIG. 5).

In a separate experiment, PEG-b-PCL is dissolved in a near critical freon under pressure and demonstrated to form spherical micelles on the basis of dynamic light scattering. When these micelles are rapidly precipitated by depressurization and subsequently redissolved in water, these micelles retain their structure and size (on the order of 100 nm) in the aqueous solution [Tyrrell, Z.; Shen, Y.; Radosz, M. Drug-Delivery Nanoparticles Formed by Micellization of PEG-b-PCL in Subcritical and Supercritical Solvents, Annual Meeting of American Institute of Chemical Engineers, November 2007, Salt Lake City].

The foregoing description and drawings comprise illustrative embodiments of the present inventions. The foregoing embodiments and the methods described herein may vary based on the ability, experience, and preference of those skilled in the art. Merely listing the steps of the method in a certain order does not constitute any limitation on the order of the steps of the method. The foregoing description and drawings merely explain and illustrate the invention, and the invention is not limited thereto, except insofar as the claims are so limited. Those skilled in the art who have the disclosure before them will be able to make modifications and variations therein without departing from the scope of the invention.

We claim:

1. A method of forming micelle or micelle-like nanoparticles which incorporate a compound, comprising steps of:
(a) dissolving in a solvent a polymer to form a solution;
(b) adding the compound to be incorporated in the nanoparticles to the solution;
(c) adjusting the temperature and pressure of the solution to near the critical temperature and pressure of the solvent; and
(d) isolating the micelles.

2. A method as defined in claim 1, wherein the polymer is selected from the group consisting of block and graft copolymers.

3. A method as defined in claim 1, wherein, instead of or in addition to the step of adjusting the temperature and pressure of the solution, the step of adding a second solvent component.

4. A method as defined in claim 3, wherein the second solvent component comprises a supercritical antisolvent.

5. A method as defined in claims 1 and 3, wherein the polymer is selected from the group consisting of poly(ethylene glycol)-block-polyesters, other blocky copolymers, and lipids.

6. A method as defined in claim 5, wherein the polymer is selected from the group consisting of PEG-b-poly(ε-caprolactone), PEG-b-poly(lactide), PEG-b-poly(carbonates), PEG-b-poly(alkylcyanoacrylates), PEG-b-poly(diethylaminoethyl methacrylate) (PDEA), PEG-b-poly(ethyleneimine) (PEI), and PEG-b-phosphotidyl ethanolamine (PE).

7. A method as defined in claims 1 and 3, wherein the solvent is selected from the group consisting of dimethyl ether, Freon, including but not limited to chlorodifluoromethane, other near-critical solvents of variable polarity, cosolvents, and antisolvents.

8. A method as defined in claims 1 and 3, wherein the compound is a therapeutic agent.

9. A method as defined in claim 8, wherein the therapeutic agent comprises a drug, a gene, or a gene treatment.
